(19) United States
(12) Patent Application Publication
(10) Pub. No.: US 2010/0023923 A1
(43) Pub. Date: Jan. 28, 2010

(54) METHOD FOR MEDELING OBJECTS IN A HETROGENIOUS COMPUTING ENVIRONMENT

(75) Inventors: Aidan Shribman, Tel-Aviv (IL); Nadav Helfman, Binyamina (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP Portals Israel Ltd, Raanana (IL)

(21) Appl. No.: 12/178,676

(22) Filed: Jul. 24, 2008

(51) Int. Cl. G06F 9/44

(52) U.S. Cl. 717/104

(57) ABSTRACT

A meta language for developing object classes to be used in multi-platform systems, optionally using multiple environments and languages. The code of the object classes comprise structure and logic. The code is converted into native languages, for example by preprocessing mechanisms, and then compiled if necessary into programs executable by the computing platforms.

Further supplied is one or more class hierarchies, supplying the basic functionality for a multiplicity of classes and persistency capabilities, so as to enable the developer to inherit the classes and further expedite development.

The meta code can also be converted into schema files, such as LDAP schema files.

### RELATED APPLICATIONS

The present application relates to international patent application serial number 11/389,890 titled METHOD AND APPARATUS FOR DELIVERING MANAGED APPLICATIONS TO REMOTE LOCATIONS filed on Mar. 27, 2006, the contents of which are incorporated herein by reference.

### TECHNICAL FIELD

The present invention relates to modeling tools in general and to modeling objects in an object oriented computerized environment in particular.

### BACKGROUND

Implementers of heterogeneous computing environments face a sisyphean task when required to implement and maintain objects used throughout the system. However, these tasks are often required because business objects such as transactions, database APIs, or others may be required system-wide. Such objects may have various manifestations into native representation on each platform participating in the object life cycle, possible including a client device, a server, a database or others, wherein each platform may require the object to be implemented in a particular programming language. Implementers are thus required to implement object Abstract Program Interfaces (APIs), control logic, validity tests and other functionalities, in multiple computer languages (such as C++, Java, C#), multiple database schemas and database objects or other environment components. For each such object and each language, implementers are required to implement importing and exporting, i.e., storing and retrieving to and from multiple targets, such as Lightweight Directory Access Protocol (LDAP) database, XML file, text file, memory buffer, or others. The tedious job repeats when the object's definition changes. All code segments implementing the object in any language, as well as LDAP schemas, database schemas and other objects should be updated. Updates should be consistent to ensure that all the various build time and runtime manifestations remain consistent throughout the system, since interoperation failure may occur if system wide consistency is not fully met.

A number of technologies attempt to solve the problem of compatible objects that have to be implemented in multiple languages and environments, and provide storing and retrieving compatibility to and from multiple targets. One technology is Common Object Request Broker Architecture (CORBA), which uses Interface Description Language (IDL) for modeling. However, CORBA is limited to handling the network transmitting of the objects between heterogeneous platforms. Such system lacks functionalities such as modeling the control logic and thus cannot save the need of re-implementation for each platform, import and export of the objects, and runtime user interface interaction. Similar technologies such as SOAP, MOF, and DCOM suffer from the same weaknesses.

Another technology suggests using CORBA with machine independent language to achieve interoperability and save the efforts invested into re-implementation of platform dependent code. However, this technology does not cover importing and exporting data into files or databases, or automatic creation of database schema files. Further, since the CORBA system using IDL is used for object representation, it does not support simple integration with user interfaces that would require serialization into text representation.

Yet another technology discloses importing and exporting data between an object oriented computing environment and an external computing environment, by encapsulating the validation, conversion, and update control mechanisms for objects. Such system enables simple binding of internal object elements to external elements thus simplifying the import and export of objects to databases. However, such system does not cover aspects needed in an end-to-end solution such as multiple-platform networks or distributed networks, including for example serialization for network transmission, cross-platform implementation among cross-computer-language, creation of data schema files and the like.

All the above-mentioned technologies enable defining interfaces and structures in a unified language from which interfaces in all required platform specific languages are derived automatically. However, the currently known technologies lack a number of abilities: (1) they do not provide for value validation of the objects. For example, a “Hostname” field may be defined as a string, but it may be required to only allow names which comply with the Fully Qualified Domain Name (FQDN) Specification (e.g. www.example.com), which requires the usage of regular expression for validation, (2) are usually strongly coupled with specific transport layers, and cannot easily be paired with propriety transport layers, such as SOAP for example. (3) do not provide for automatic generation of database schema from the object description; and (4) do not support the possibility of setting default values for attributes of the objects.

There is thus a need in the art for a system and method that will reduce the effort required for implementing corresponding objects in multiple environments and multiple computing languages, as well as for providing import and export capabilities for the objects, to and from multiple targets.

### SUMMARY

A method and apparatus for enabling fast, efficient and consistent development of objects for a cross-platform environment. The method and apparatus provide a class hierarchy and a modeling language for deriving objects suitable for the application from the class hierarchy.

In one embodiment of the disclosure, there is thus provided a method for enabling modeling an object, the object to be used cross-platform by a first service or application executed by a first computing platform employing a first computing environment, and by a second service or application executed by a second computing platform employing a second computing environment, the method comprising: providing a class hierarchy comprising a description in a modeling language of one or more classes, so as to enable derivation of the object to be developed from the one or more class; and providing a conversion instruction, the conversion instruction converting the description of the object to be developed from the modeling language into codes written in one or more native languages. The method can further comprise the step of providing the modeling language, or the step of providing a schema generator for generating a schema from the description of the object or from the native language codes. Within the method, the conversion instruction is optionally applied using a preprocessing component. Within the method, a description is optionally provided for one or more classes of the class hierarchy, comprising two or more items selected from the group consisting of: default values to be set during creation; verification code; object duplication manner; and relations between elements in the class. Within the method, the class hierarchy optionally comprises descriptions for: an attribute class comprising a name and value pair; a complex class comprising a set of elements, wherein each element is of attribute class, complex class or list class; and a list class comprising an ordered list of elements, wherein each element is of attribute class, complex class, or list class. Within the method, the attribute class is optionally selected from the group consisting of: an integer attribute class; a Boolean attribute class; a string attribute class; an IP attribute class; a regular expression attribute class; a port attribute class; and a bitmask attribute class. Within the method, the class hierarchy optionally comprises a target hierarchy comprising one or more target object, wherein each target object represents an interaction of an object with an external target. Within the method, the external target is optionally selected from the group consisting of: LDAP database, XML file; text file; and memory. The method optionally allows for development of a consistent cross-environment object.

In another embodiment of the disclosure, there is thus provided in a cross-platform environment comprising a first computing platform employing a first computing environment and executing a first service or application, and a second computing platform employing a second computing environment and executing a second service or application, the first service or application using a first representation of an object to be developed and the second service or application using a second representation of the object to be developed, a method for modeling the object, the method comprising: receiving a class hierarchy comprising descriptions of one or more classes; deriving an object from a class description and providing an object description for the object; and converting the object description into one or more native code units. The method can further comprise the steps of: compiling the native code units into one or more executable units; and executing the executable units or an application or service associated with the native code units.

Another aspect of the disclosure relates to an apparatus for modeling an object, the object to be used by a first service or application executed by a first computing platform employing a first computing environment, and by a second service or application executed by a second computing platform employing a second computing environment, the apparatus comprising: a class hierarchy comprising a description in a modeling language of one or more classes, allowing derivation of the object to be developed from the classes; and a conversion instruction for converting the description of the object to be developed from the modeling language into one or more native language code units. The apparatus can further comprise an execution script for activating the conversion instructions, or a makefile for associating one or more files coded in the modeling language and the native language code units. The apparatus can further comprise a schema generator for generating one or more database schema or LDAP schema from one or more files coded in the modeling language or from the native language code units. Within the apparatus, the class hierarchy optionally comprises: an attribute class comprising a name and value pair; and a complex class comprising a set of elements, wherein each element is of attribute class, complex class or list class. Within the apparatus, the class hierarchy optionally further comprises a list class comprising an ordered list of elements, wherein each element is of attribute class, complex class, or list class. Within the apparatus, the attribute class is optionally selected from the group consisting of: an integer attribute class; a Boolean attribute class; a string attribute class; an IP attribute class; a regular expression is attribute class; a port attribute class; and a bitmask attribute class. Within the apparatus, the class hierarchy optionally comprises a target hierarchy comprising one or more target objects, wherein each target object represents an interaction of an object with an external target. Within the apparatus, the external target is optionally selected from the group consisting of: LDAP database XML file; text file; and memory.

Yet another aspect of the disclosure relates to a class hierarchy comprising descriptions for: an attribute class comprising a name and value pair; a complex class comprising a set of elements, wherein each element is of attribute class, complex class or list class; and a list class comprising an ordered list of elements, wherein each element is of attribute class, complex class, or list class. Within the class hierarchy, the descriptions optionally comprise for one or more classes, two or more items selected from the group consisting of: default values to be set during creation; verification code; object duplication manner; and relations between elements in the class.

Yet another aspect of the disclosure relates to a computer readable storage medium containing a set of instructions for a general purpose computer, the set of instructions comprising: a class hierarchy comprising a description in a modeling language of one or more classes, so as to enable derivation of the object to be developed from the classes, the description provided in the modeling language; and a conversion instruction, the conversion instruction converting the description of the object to be developed from the modeling language into one or more native language code units.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 is a schematic block diagram of a typical computing environment in which the disclosed method and apparatus are used;

FIG. 2 shows a schematic illustration of the stages and products of the disclosed method and apparatus;

FIG. 3A shows a schematic class diagram of a specific hierarchy object repository, in accordance with the disclosure;

FIG. 3B shows a schematic class diagram of a target class hierarchy, in accordance with the disclosure;

FIG. 4 is a flowchart of the main steps in a preferred implementation of a method, in accordance with the disclosure; and

FIG. 5 is a schematic block diagram of the main components in a preferred implementation of an apparatus, in accordance with the disclosure.

### DETAILED DESCRIPTION

The present subject matter provides for a method and apparatus for defining an object to be used in a distributed application. The object is modeled once, and the single definition is used for automatically deriving multiple manifestations of the object to be used by one or more applications or services throughout a landscape, across multiple programming languages, programming environments, data storage and data transport protocols. The landscape is typically a distributed network, such as a network comprising a multiplicity of computing platform, connected through a communication channels such as a Wide Area Network (WAN), Local Area Network (LAN), the Internet or others.

The apparatus and method thus enable the coding of a single description of an object in a meta-language, and the generation of multiple specific representations of the object, from the single description. A meta language is a language used to make statements about statements in another language. The description of the objects optionally includes data members of the object, as well as default values to be set during creation, verification code, object duplication manner, maintaining relations between various elements in the object, and the like.

Using a component such as preprocessor, multiple specific representations are generated from a single description. Further, objects such as database schemas and Interface Definition Language (IDL) files can be generated from the single description or from one or more of the automatically generated specific representations. Thus, the single description can be used for generating specific objects to be compiled and used in one or more platforms, such as Linux or Windows, each specific object implemented in one or more programming language and more preferably object-oriented programming language such as C++, C# or Java, and uses one or more persistent representations, such as LDAP, XML, clear text or others. Database schemas and IDL files can also be generated from the specific object.

Further disclosed is an abstract object hierarchy or repository, optionally termed Hierarchy Object Repository (HOR). The hierarchy comprises the description of elements useful in representing a large variety of objects in general, and business objects, such as transaction definition, node configuration or component configuration, in particular. The description comprises the objects' interface as well as logic of the classes. Each object modeled in the meta language inherits directly or indirectly from a class in the HOR, and thus inherits automatically all the functionality associated with the ancestor class, including import and export capabilities (also referred to as input and output, or storage and retrieval) for multiple targets.

The HOR comprises a basic item, named for example Item_Base. A number of classes inherit Item_Base, including an Attr (short for attribute), a node and a list. The Attr implements a simple, or primitive attribute class, consisting of a name and value pair. The Node is a complex class represents a container of objects of the Attr, Node, or List classes, and the List comprises an ordered list of objects of the Attr, Node or List classes.

The HOR further comprises a target hierarchy, which represents the interaction of an Item_Base with external resources, enabling to save or load the object to or from LDAP database, XML file, Text file, memory retained buffer, or others. The target objects also enable the creation of LDAP schemas.

The NOR can be implemented in any object-oriented programming language, as long as a mechanism for translating the code into any other required languages is provided. In another embodiment, the HOR is implemented in a proprietary language, named for example metaJ. Conversion directions are supplied for converting metaJ code into any required language, such as C++, C#, Java or any well-defined object-oriented programming language, using for example a preprocessing mechanism.

In the current disclosure, the terms “class” and “object” may be used interchangeably. The general distinction in object-oriented programming is that a class provides a description and optionally static members, while an object is an actual data structure comprising actual data, and constructed in run-time upon the class definition of the class it relates to. Thus, a class is generally designed and coded in design time or implementation time, while in runtime objects are constructed of one or more classes. However, in the context of the disclosure, the term “object” is also used for identifying real-world objects, such as a network, a computing platform, a transaction, a customer, or others. Therefore, when the text relates for example to designing, deriving, or coding an object, the term generally and usually refers to designing or implementing a class which describes the real-world object.

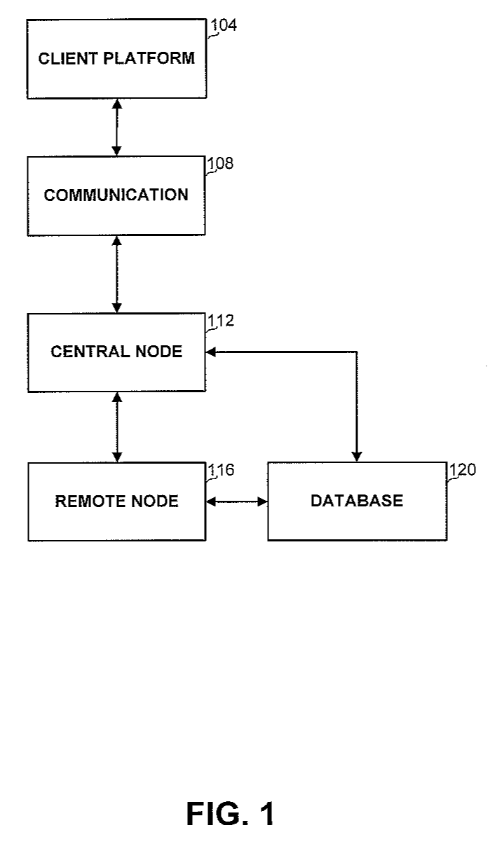

Referring now to FIG. 1, showing an exemplary environment, demonstrating the need for an apparatus and method for efficient development of classes to be used throughout a system. The environment comprises two or more computing platforms, employing two or more computing environments. Each platform may be executing one or more applications or service, wherein the applications or services may be developed in two or more languages. The applications or services are using one or more common objects, wherein each common object has a different representation or manifestation in the different environment and language. A user may be, for example, operating a client-side of an application executed on a client platform 104. The application can be, for example a web application or a web service implemented in Java under the J2EE development environment. The data sent or received by the application is transferred via various communication channels 108, using protocols such as LDAP or others.

The client-side web application executed on client platform 104 is in communication with a server-side application executed on a central node 112. Central node 112 is optionally a server located in a geographical site remote from client platform 104, and providing services to multiple client platforms. The server-side application is optionally implemented in C++ or another programming language.

Central node 112 is optionally in communication with remote node 116 which also executes one or more applications, for example another application implemented in C++. Central node 112 or remote node 116 may be in communication with database 120, which uses further another format of data. Thus, the same objects, such as objects representing transactions, or node configuration are used throughout the system, wherein the objects have to be implemented in two or more environments or languages, such as Java, C++, C#, LDAP, Portal Data Viewer (PDV) or others.

It will be appreciated that client platform 104, central node 112 and remote node 116 are preferably computing platforms such as a handheld device, a Personal Digital desktop computer, a server, a mainframe computer or others. The computing platforms are interconnected using any communication channel such as a Local Area Network, a wide Area Network, the Internet or any other wired or wireless channel using any commercial or proprietary protocol.

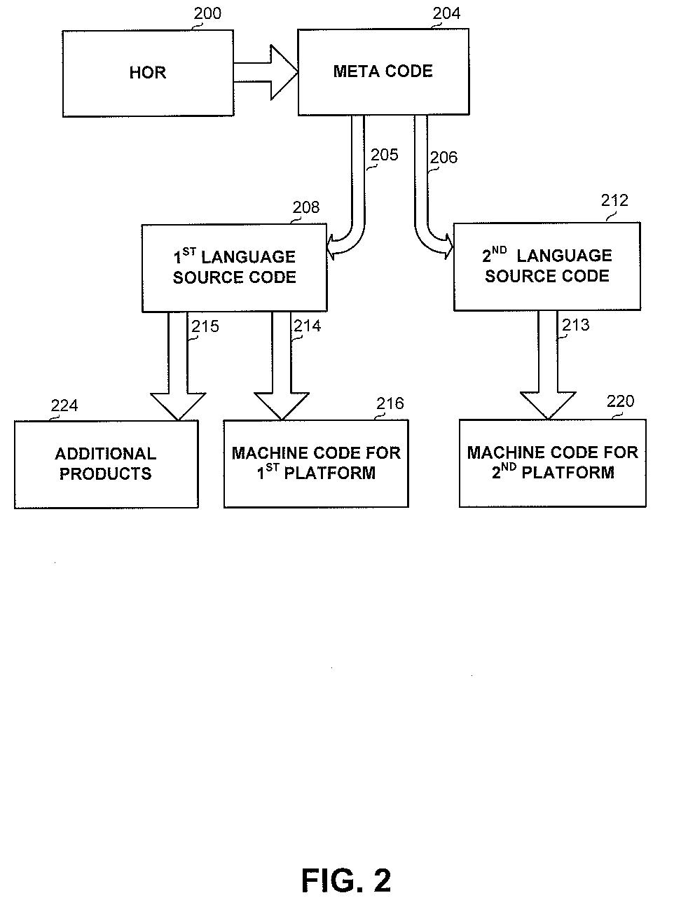

Referring, now to FIG. 2, showing the code, schemas and executable entities within the environment when using the disclosed method and apparatus. A user that is required to implement an application uses HOR classes and utilities 200 and implements the required objects by writing code 204, using the meta language at which the HOR classes are implemented. The meta code is then converted on steps such as 205 or 206 into code 208 or 212, written in one or more native language code such as C++, C#, Java or others. On steps such as 213 or 214, the native code is compiled using the appropriate compilers, such as a C++ compiler for C++ code. Java compiler for Java code, or the like, into executable code. The compilers generate the appropriate machine code, for example, machine code for first computing platform 216 or machine code for second computing platform 220.

Optionally, one or more of the native code units is also used on step 215 for generating additional products 224, such as an LDAP schema, a database schema, or the like.

The various units can then be executed as part of, or in connection with applications executed on the respective computing platforms. Since all objects stem from the same code, cross-system compatibility and behavior consistency of the objects is provided.

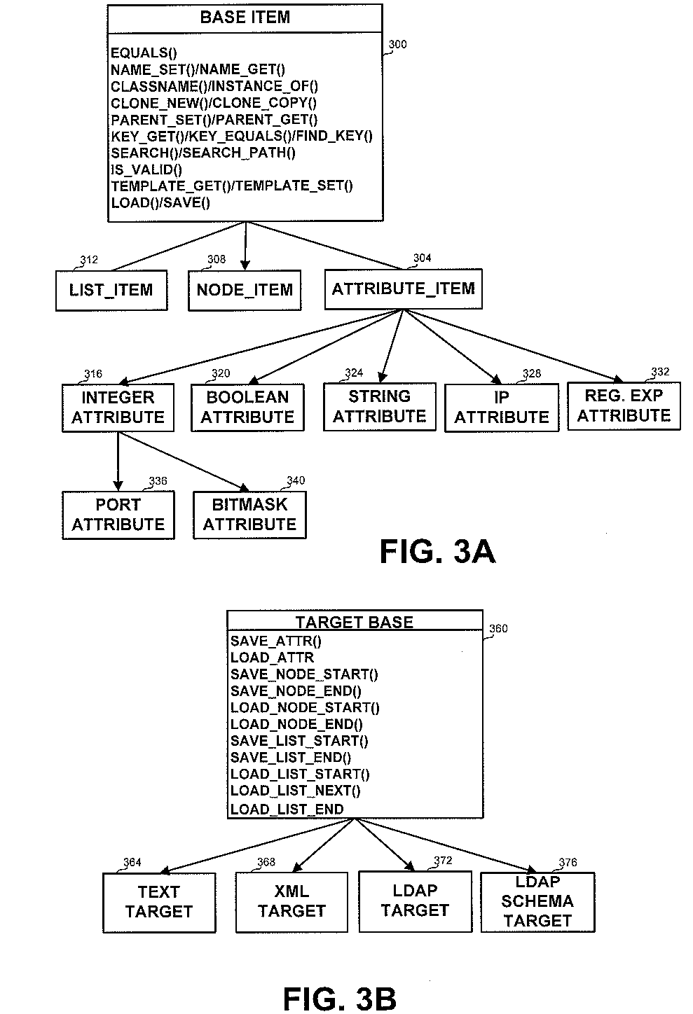

Referring now to FIG. 3A, showing a specific hierarchy object repository, which can be used as a base class hierarchy for multiple applications, including for example business applications. At the base of the hierarchy, there is a base_item class 300. Base_item class 300 is inherited by attribute_item class 304, which implements a pair of name and value. Another class inheriting base-item 300 is node_item 308 which implements a collection of base_item objects or objects inheriting base_item. Node_item 308 keeps a set or another data structure of the items it contains, so the items can be traversed. Yet another class inheriting base-item 300 is list_item 312 which implements an ordered list of base_item objects or objects inheriting base_item. As for the node_item, the list_item keeps track of the elements on the list, so as to enable traversal. Attribute_item class 304 is inherited by a number of classes, each implementing a particular value type, such as integer attribute class 316, Boolean attribute class 320, string attribute class 324, IP attribute class 328, and regular expression attribute class 332. For example, IP attribute class 324 comprises a validity check that the value is of the form x.y.z.w, while x, y, z and w are between 0 and 255. Integer attribute class 316 is further inherited by port attribute class 336, and by bitmask attribute class 340, wherein the port number or the bitmask are implemented as integers with additional limitations.

Base_item 300 implements a number of methods applicable to all objects, including: equal for comparing two objects; name_set and name_get for setting and retrieving the object's name; classname and instance of for getting the name of the class and determining whether an object is of a particular type; clone_new for creating a new object and cloning the content of an existing one; clone_copy for cloning the copy of a first existing object into a second existing object; parent_set and parent_Get for setting and getting the parent of a base_item object; key_get key_set and key_equals for setting getting and comparing keys of objects; search and search_Path for searching for a particular object within a list or node; is-valid for validating the integrity of an object; template_get and template_set for defining initiated objects which can be used as a template for newly created object, and load and save methods. The load and save method receive as parameter a target, such as XML, string, memory or the like. Each descendant object may override any one or more of the item_base methods, or avoid overriding them and use the base_item's implementation. For example, a “save” method for an item_list generally traverses the list and calls “save” for each item in the list.

When a new class is defined, inheriting any of the classes in the class hierarchy, it is optionally defined to contain members of the various classes. For example, if a Network class is defined, which inherits the node class, it may ne assigned a hostname member which is defined to be of string_attribute class, and an IP address member defined to be of IP_attribute class. The members are registered with the class, so that the class is aware of its members and can iterate them when performing operations such as save, load or others.

Referring now to FIG. 3B, showing a target class hierarchy, designed to import and export (e.g. load and save) objects of type base_item class 300 or a descendant thereof, whether the descendant is provided as part of the HOR or is user-implemented. At the base of the hierarchy there is a target_base class 360, which provides the basic functionality. For each supported target, a new class is defined, inheriting the base class, for example text target class 364, XML_target class 368, or LDAP target class 372. It will be appreciated that further inheriting classes can be added, for any required target, such as memory. A further class inheriting target base class 360 is LDAP schema target class 376, which When an object is to be saved to, or loaded from a specific target, a method of an object of the relevant target class is retrieved, receives the relevant object of node class (or an inheriting class) and saves or loads the object to or from itself (being the target object). The basic functionality of target base 360 includes methods for saving or loading an object of type attribute_item, which is an atomic value, methods for saving and loading an object of class node_item, which traverse all the members of the node as registered and methods for saving and loading an object of class list_item, which traverse the list of node_items of the

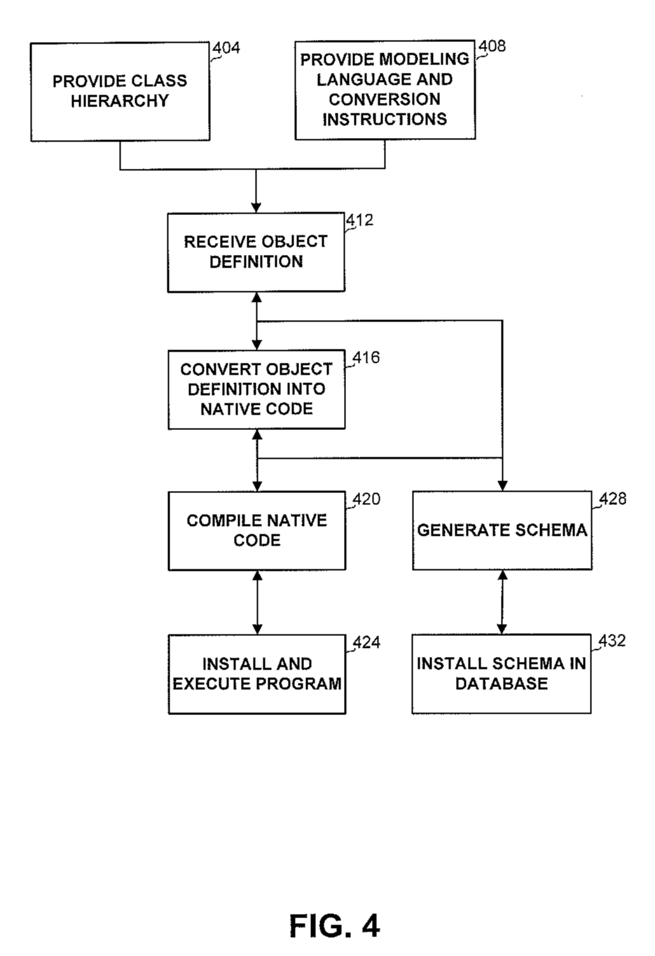

Referring now to FIG. 4, showing a flowchart of the main steps in a preferred implementation of a method. The method starts by providing on step 404 a class hierarchy, also referred to as class foundation or class repository, which should be appropriate for and associated with the subject matter of the applications to be developed. For example, distributed business applications can benefit from a class hierarchy such as the hierarchy shown on FIG. 3A above. It will be appreciated that the class hierarchy can have multiple ancestors, and does not necessarily inherit from a single ancestor.

On step 408, a modeling language is provided, together with conversion instructions. Optionally, the hierarchy provided on step 404 should be in the modeling language of step 408. The language provided on step 408 can be a native language such as C++ or java, but can alternatively be a proprietary language, adapted to the requirements of the applications to be developed. The conversion instructions should enable conversion from the language at which the hierarchy is provided to all native languages used in the system. Thus, if the modeling language is a native language, one less conversion will be required, but due to the complexity of the native languages, the other conversions will be more complex. On the other hand, if the modeling language is a proprietary language, conversions will be required to all native languages, but since the modeling language is simpler, the conversion will be simpler as well. It will be appreciated that if the modeling language is not a native language, it should contain commands sufficient for enabling the programming of logic and operations, while being simple enough so it can be translated into any native language, or in other words lie within the common denominator of the native languages. For example, such modeling language should provide a user with the following options: derive a class from an existing class; add a member to a class, the member having a known type; and add functionality to the class. The modeling language should take care of managing the members of a class, enable iteration through the members and provide input and output functionality. In addition the language must support basic control statements such as if, else, while, do, for, continue, break; basic generic types such as: integer, float, Boolean, character, string, and basic containers such as: vector, list, or map.

On step 412, a definition of one or more objects, programmed in the modeling language are received from a user. One or more of the objects can be independent objects, or can inherit from any of the objects of the hierarchy provided on step 408. Unlike prior art solutions, the code can include logic and operations related to the objects, such as performing operations, checking validity or the like.

On step 416, the definition of one or more objects are converted into code unit, such as a module, a file, a library or others, in one or more native languages, such as C++ or Java. Conversion can be performed, for example by using a preprocessing mechanism, other methods for text substitution, or the like. When using a mechanism of preprocessing, the “#IFDEF” and “#DEFINE” pragmas, or any other method for translation.

On step 420, the native code is compiled, if necessary, into machine code. If the native code is run by an interpreter, compilation is not required. Compilation is performed using a compiler, as for any other code, whether written by a user, produced by a wizard or received otherwise. It will be appreciated that if the object definition was converted into multiple native language codes, all of the codes will have to be compiled, each one with a corresponding compiler.

On step 424 the programs produced from the compiled codes are optionally installed and executed on the respective computing platforms.

On optional step 428, one or more schemas, such as database schemas or LDAP schemas are generated from the automatically generated native code representing the modeled object. The LDAP schema provides instructions on how to define attributes (for Attr_Item objects) or data containers (for List_Item and Node_Item objects) in an LDAP schema language. Objects are being stored or retrieved to or from the LDAP database by an LDAP schema target, such as LDAP schema target 376 of FIG. 3.

On optional step 432, the generated LDAP schema is installed in one or more LDAP databases, so that objects of the hierarchy from which the schema was generated can be saved or loaded to or from the LDAP database. It will be appreciated that the LDAP schema is generated during build time, installed after the LDAP server is placed on the target machine as part of the LDAP server configuration, and then referenced by the LDAP server during run-time for storing or fetching objects by the LDAP client.

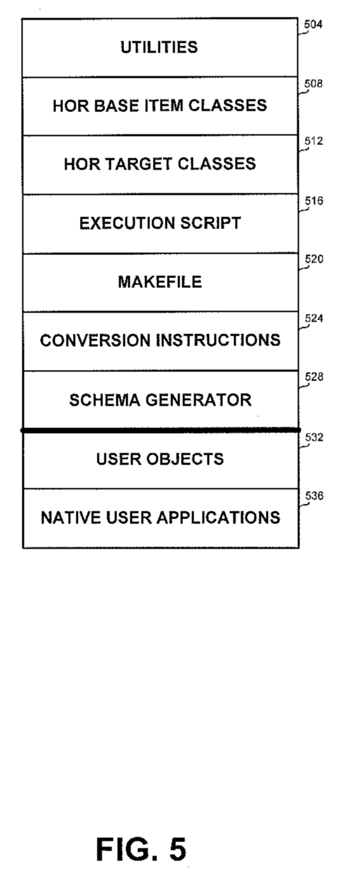

Referring now to FIG. 5, showing a block diagram of the components in a preferred embodiment of a system for modeling objects cross-platform in a rapid, efficient, or consistent manner. Each component of the apparatus preferably comprises one or more interconnected sets of computer instructions designed to perform the methods of the disclosure. Some sets may comprise instructions in machine language, while others may comprise human-readable code comprising for example classes, from which further classes are to inherit. The instructions are to be executed by one or more general purpose computers, each comprising at least a central processing unit (CPU) and a memory unit. Some components may require specific platforms such as Java Virtual Machine (JVM).

The apparatus comprises utilities module 504, which contains general utility methods or functions, such as string handling, integer to ASCII conversion and vice versa, or the like. The apparatus also comprises a class library 508, comprising a class hierarchy such as shown and described in association with FIG. 3A above. The class hierarchy may comprise any type or number of classes, according to the applications to be constructed.

Another class library supplied is target classes 512, which provides import and export capabilities for the objects of class library 508. The apparatus further comprises an execution script 516 for converting the meta code into native code. The conversion may have to be performed in a number of iterations, and execution script 516 is responsible for managing the conversion.

Yet another component is a makefile 520, which connects the meta input files with the generated native code files, for example a “xxx.metaj” file is the source for “xxx.h” C++ file. Another component is conversion instructions 524, which contain the actual conversion instructions, for example the phrase “CLASS xx EXTENDS yy” is translated in C++ into “class xx: public yy”, and in Java into “class xx extends yy”.

In order to generate schemas, such as database schema files or LDAP files, the apparatus comprises schema generator 528.

The components and code segments listed above are provided to a user for developing a distributed application. The user then codes some objects 532, using the modeling language in which the class hierarchies were written in, converts the code into native language, and if required compiles the native language code. These steps provide the user with the relevant objects that are used in multiple platforms throughout the environment in which the application is executed. The user then goes on to code the separate parts of the application, using the now available common objects. For example, the user now codes a user interface for an application using Java under J2EE, a server application in C++, or other components.

It will be appreciated by a person skilled in the art that the provisioning of the components detailed above is also covered and protected by the current disclosure.

In the disclosure above, the terms class and object may have been used interchangeably. The general distinction in object-oriented programming is that a class provides a description and optionally static members, while an object is an actual data structure comprising actual data, and constructed upon the class definition of the class it relates to. Thus, a class generally refers to design time, while in run time objects are constructed of one or more classes. However, in the context of the disclosure, the term “object” is also used for identifying real-world objects, such as a network, a computing platform, a transaction, a customer, or others. Therefore, when the text relates to designing, deriving, or coding an object, the term generally and usually refers to designing a class which describes the real-world object.

The disclosed method and apparatus provide for efficient development of cross-platform objects. Objects, including their structure, operations, and logic are programmed in a meta language, converted into native languages, compiled and executed. The method and apparatus ensure automatic object consistency throughout a distributed system. A class hierarchy that provides a set of classes and operations for the particular application saves further effort from the developer. Import and export operations for the objects are also supported, for any required target. The meta language code can also be used for generating schemas, such as LDAP schemas or other database schemas, so that correspondence of the objects and their storage is provided as well.

It will be appreciated that there multiple variations of the meta language can be defined, which are small enough so that the generated code can be converted into any native code, but can still provide all functionality required for objects within the environment.

The disclosed method and apparatus enable fast development of applications, while ensuring cross-platform compatibility and persistence compatibility.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed:

1. A method for enabling modeling an object, the object to be used cross-platform by a first service or application executed by a first computing platform employing a first computing environment, and by a second service or application executed by a second computing platform employing a second computing environment, the method comprising:
providing a class hierarchy comprising a description in a modeling language of an at least one class, so as to enable derivation of the object to be developed from the at least one class; and
providing a conversion instruction, the conversion instruction converting the description of the object to be developed from the modeling language into an at least one native language code.

2. The method of claim 1 further comprising the step of providing the modeling language.

3. The method of claim 1 further comprising the step of providing a schema generator for generating a schema from the description of the object or from the at least one native language code.

4. The method of claim 1 wherein the conversion instruction is applied using a preprocessing component.

5. The method of claim 1 wherein for at least one class of the class hierarchy, a description is provided comprising at least two items selected from the group consisting of: default values to be set during creation; verification code; object duplication manner; and relations between elements in the class.

6. The method of claim 1 wherein the class hierarchy comprises descriptions for:
an attribute class comprising a name and value pair;
a complex class comprising a set of elements, wherein each element is of attribute class, complex class or list class; and
a list class comprising an ordered list of elements, wherein each element is of attribute class, complex class, or list class.

7. The method of claim 6 wherein the attribute class is selected from the group consisting of: an integer attribute class; a Boolean attribute class; a string attribute class; an IP attribute class; a regular expression attribute class; a port attribute class; and a bitmask attribute class.

8. The method of claim 1 wherein the class hierarchy comprises a target hierarchy comprising an at least one target object, wherein each target object represents an interaction of an object with an external target.

9. The method of claim 8 wherein the external target is selected from the group consisting of: LDAP database, XML file; text file; and memory.

10. The method of claim 1 wherein the method allows for development of a consistent cross-environment object.

11. In a cross-platform environment comprising a first computing platform employing a first computing environment and executing a first service or application, and a second computing platform employing a second computing environment and executing a second service or application, the first service or application using a first representation of an object to be developed and the second service or application using a second representation of the object to be developed, a method for modeling the object, the method comprising:
receiving a class hierarchy comprising an at least one class description;
deriving an object from the at least one class description and providing an object description for the object; and
converting the object description into an at least one native code unit.

12. The method of claim 11 further comprising the steps of:
compiling the at least one native code unit into an at least one executable unit; and
executing the into an at least one executable unit or an application or service associated with the at least one native code unit.

13. An apparatus for enabling the modeling of an object, the object to be used by a first service or application executed by a first computing platform employing a first computing environment, and by a second service or application executed by a second computing platform employing a second computing environment, the apparatus comprising:
a class hierarchy comprising a description in a modeling language of an at least one class, allowing derivation of the object to be developed from the at least one class; and
a conversion instruction for converting the description of the object to be developed from the modeling language into an at least one native language code unit.

14. The apparatus of claim 13 further comprising an execution script for activating the conversion instructions.

15. The apparatus of claim 13 further comprising a makefile for associating at least one file coded in the modeling language and the at least one native language code unit.

16. The apparatus of claim 13 further comprising a schema generator for generating an at least one database schema or LDAP schema from an at least one file coded in the modeling language or from the at least one native language code unit.

17. The apparatus of claim 13 wherein the class hierarchy comprises:
an attribute class comprising a name and value pair; and
a complex class comprising a set of elements, wherein each element is of attribute class, complex class or list class.

18. The apparatus of claim 17 wherein the class hierarchy further comprises a list class comprising an ordered list of elements, wherein each element is of attribute class, complex class, or list class.

19. The apparatus of claim 17 wherein the attribute class is selected from the group consisting of: an integer attribute class; a Boolean attribute class; a string attribute class; an IP attribute class; a regular expression attribute class; a port attribute class; and a bitmask attribute class.

20. The apparatus of claim 13 wherein the class hierarchy comprises a target hierarchy comprising an at least one target object, wherein each target object represents an interaction of an object with an external target.

21. The apparatus of claim 17 wherein the external target is selected from the group consisting of: LDAP database XML file; text file; and memory.

22. A class hierarchy comprising descriptions for:
an attribute class comprising a name and value pair;
a complex class comprising a set of elements, wherein each element is of attribute class, complex class or list class; and
a list class comprising an ordered list of elements, wherein each element is of attribute class, complex class, or list class.

23. The class hierarchy of claim 22 wherein the descriptions comprise for at least one class, at least two items selected from the group consisting of default values to be set during creation; verification code; object duplication manner; and relations between elements in the class.

24. A computer readable storage medium containing a set of instructions for a general purpose computer, the set of instructions comprising:
a class hierarchy comprising a description in a modeling language of an at least one class, so as to enable derivation of the object to be developed from the at least one class, the description provided in the modeling language; and
a conversion instruction, the conversion instruction converting the description of the object to be developed from the modeling language into an at least one native language code units.
